(19) United States
(12) Patent Application Publication
(10) Pub. No.: US 2025/0151674 A1
(43) Pub. Date: May 15, 2025

(54) PORTABLE LANDSCAPING CART VACUUM AND METHOD OF USE

(71) Applicant: Angel Diaz, Providence, RI (US)

(72) Inventor: Angel Diaz, Providence, RI (US)

(21) Appl. No.: 18/905,653

(22) Filed: Oct. 3, 2024

Related U.S. Application Data
(60) Provisional application No. 63/598,714, filed on Nov. 14, 2023.

(51) Int. Cl. A01G 20/47

(52) U.S. Cl. CPC A01G 20/47

(57) ABSTRACT

A portable landscaping tool is disclosed. The device comprises a durable, substantially horizontal platform mounted on casters or wheels for easy portability across diverse terrains. The tool includes a high-powered vacuum device which includes a motor. A vacuum hose is attached to the vacuum cleaner for efficient collection of leaves and debris. The collected debris is directed through a connected hollow pipe to a vertical dispenser, which ejects the material through a dispensing end with a protective pivoting cap. The platform includes a metal stand with chains to support additional landscaping tools. A handle at the front end facilitates easy maneuverability of the device.

### CROSS-REFERENCE TO RELATED APPLICATION

The present application claims priority to, and the benefit of, U.S. Provisional Application No. 63/598,714 which was filed on Nov. 14, 2023 and is incorporated herein by reference in its entirety.

### FIELD OF THE INVENTION

The present invention generally relates to the field of landscaping tools. More specifically, the present invention relates to a portable landscaping device designed to perform various yard maintenance tasks efficiently. The device features a durable platform on casters for easy movement across different terrains, a high-powered vacuum cleaner apparatus with a flexible hose for collecting leaves and debris, and a vertical dispenser for ejecting collected material. The device also includes a user-friendly control panel and integrated tool support systems. Accordingly, the present disclosure makes specific reference thereto. Nonetheless, it is to be appreciated that aspects of the present invention are also equally applicable to other like applications, devices, and methods of manufacture.

### BACKGROUND

By way of background, several labor-intensive tasks such as mowing grass, raking leaves, trimming hedges, and other landscaping projects are necessary for maintaining a well-kept lawn. Such activities are often time-consuming and require a significant investment of effort and energy. As a result, many homeowners resort to hiring professional landscapers to manage these tasks, which can be costly. The expense of professional landscaping services can quickly add up, making it an impractical solution for regular maintenance for many individuals.

Moreover, individuals often lack the necessary tools to perform all the required landscaping tasks effectively. The absence of appropriate equipment not only makes the tasks more challenging but also results in a less than satisfactory outcome. A lack of proper tools can lead to incomplete leaf collection and other issues that detract from the overall appearance of the lawn. Consequently, there is a need for a comprehensive, user-friendly landscaping tool that can help individuals efficiently perform various landscaping tasks without the need for professional help

Therefore, there exists a long-felt need in the art for a versatile and efficient landscaping tool that enables individuals to perform various yard maintenance tasks without the need for professional services. There is also a long-felt need in the art for a comprehensive device that integrates multiple functionalities, such as vacuuming leaves, collecting debris, and dispensing waste, et. al., in order to streamline the landscaping process. Additionally, there is a long-felt need in the art for a portable and user-friendly tool that can be easily maneuvered across different terrains, reducing the physical strain associated with traditional yard work. Moreover, there is a long-felt need in the art for a solution that minimizes the time and effort required to maintain a clean and professional-looking lawn, while being cost-effective and accessible to a wide range of users. Furthermore, there is a long-felt need in the art for a landscaping device that supports the use of various landscaping tools and accessories, enhancing its versatility and efficiency. Finally, there is a long-felt need in the art for a device that incorporates durable materials and ergonomic design features to ensure long-term usability and comfort during operation.

The subject matter disclosed and claimed herein, in one embodiment thereof, comprises a portable landscaping cart that enables users to independently complete landscaping projects without hiring professional help. The cart comprises a substantially horizontal platform made of durable material, a plurality of casters attached to a bottom surface of the platform for easy portability on various indoor and outdoor surfaces, a vacuum cleaner apparatus includes a high-powered electric or battery-operated motor to generate suction force, a vacuum hose is attached to a vacuum port of the platform, the hose is flexible and has an open end for collecting leaves and debris, a dispenser extends vertically from the platform and includes a hollow pipe connected to the hose for receiving and dispensing collected debris through a dispensing end, and a handle is integrated into the front end of the platform for pushing and pulling the device. The cart is adapted to transport tools and items needed for different landscaping projects.

In this manner, the portable landscaping device of the present invention accomplishes all of the foregoing objectives and provides a novel solution for efficient and user-friendly yard maintenance. The device includes a durable, substantially horizontal platform mounted on casters for easy maneuverability on various terrains. It is equipped with a high-powered vacuum cleaner apparatus featuring an electric or battery-operated motor that generates a strong suction force for collecting leaves and debris. The flexible vacuum hose, which can be secured or detached as needed, directs the collected material to a vertical dispenser via a connected hollow pipe. The dispenser efficiently ejects the debris through a dispensing end equipped with a protective pivoting cap. Additionally, the device includes metal stands with chains for supporting (i.e., suspending) various landscaping tools, such as a leaf collector positioned at the open end of the vacuum hose. The user-friendly control panel enables for easy operation and adjustment of the vacuum's suction power.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a portable landscaping device. The device comprises a substantially horizontal platform made of durable material, a plurality of casters attached to a bottom surface of the platform for easy portability on various indoor and outdoor surfaces, a vacuum cleaner apparatus includes a high-powered electric or battery-operated motor to generate suction force, a vacuum hose is attached to a vacuum port of the platform, the hose is flexible and has an open end for collecting leaves and debris, a dispenser extends vertically from the platform and includes a hollow pipe connected to the hose for receiving and dispensing collected debris through a dispensing end, and a handle is integrated into the front end of the platform for pushing and pulling the device.

In yet another embodiment, a method of using a portable landscaping device for landscaping is described. The method includes the steps of providing a portable landscaping cart, the cart includes a vacuum cleaner apparatus including a high-powered electric or battery-operated motor to generate suction force, a vacuum hose attached to a vacuum port of the platform, the hose being flexible and having an open end for collecting leaves and debris, a dispenser extending vertically from the platform, including a hollow pipe connected to the hose for receiving and dispensing collected debris through a dispensing end, the method further includes positioning the device at an appropriate location for collecting and dispensing landscaping material, activating the vacuum cleaner apparatus to generate suction in a vacuum hose and dispensing action in a dispenser, using the vacuum hose to collect landscaping material, with the material being transferred through the hose towards the dispenser, and dispensing the collected material through a dispensing end of the dispenser at a disposal area.

In another aspect, a portable landscaping tool is disclosed and includes a plurality of casters, a vacuum cleaner apparatus including a high-powered electric or battery-operated motor to generate suction force, a vacuum hose attached to a vacuum port of the platform, the hose being flexible and having an open end for collecting leaves and debris, a user-friendly control panel for controlling the vacuum cleaner apparatus, a dispenser extending vertically from the platform, including a hollow pipe connected to the hose for receiving and dispensing collected debris through a dispensing end, one or more chains operatively connected to a metal stand fastened to the platform for supporting (i.e., suspending) landscaping tools, a handle integrated into the front end of the platform for pushing and pulling the device, and a leaf collector positioned at the open end of the vacuum hose for guiding leaves and debris into the hose.

In still another aspect, the vacuum hose is secured to the vacuum port using a lock, and the lock can be released to detach the hose for replacement or when not in use.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of portable landscaping device of the present invention in accordance with the disclosed structure;

FIG. 2 illustrates a perspective view showing users carrying the landscaping cart device of the present invention in accordance with the disclosed structure;

FIG. 3 illustrates a perspective view showing a user performing landscaping using the multipurpose landscaping cart of the present invention in accordance with the disclosed structure;

FIG. 4 illustrates a perspective view of showing a user holding the hose for performing landscaping in accordance with the disclosed structure; and

FIG. 5 illustrates a flow chart depicting a process of operation of the landscaping cart of the present invention in accordance with one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a versatile and efficient landscaping tool that enables individuals to perform various yard maintenance tasks without the need for professional services. There is also a long-felt need in the art for a comprehensive device that integrates multiple functionalities, such as vacuuming leaves, collecting debris, and dispensing waste, to streamline the landscaping process. Additionally, there is a long-felt need in the art for a portable and user-friendly tool that can be easily maneuvered across different terrains, reducing the physical strain associated with traditional yard work. Moreover, there is a long-felt need in the art for a solution that minimizes the time and effort required to maintain a clean and professional-looking lawn, while being cost-effective and accessible to a wide range of users. Furthermore, there is a long-felt need in the art for a landscaping device that supports the use of various landscaping tools and accessories, enhancing its versatility and efficiency. Finally, there is a long-felt need in the art for a device that incorporates durable materials and ergonomic design features to ensure long-term usability and comfort during operation.

The present invention, in one exemplary embodiment, is a portable landscaping tool which includes a plurality of casters, a vacuum cleaner apparatus including a high-powered electric or battery-operated motor to generate suction force, a vacuum hose attached to a vacuum port of the platform, the hose being flexible and having an open end for collecting leaves and debris, a user-friendly control panel for controlling the vacuum cleaner apparatus, a dispenser extending vertically from the platform, including a hollow pipe connected to the hose for receiving and dispensing collected debris through a dispensing end, one or more chains operatively connected to a metal stand fastened to the platform for supporting (i.e., suspending) landscaping tools, and a leaf collector positioned at the open end of the vacuum hose for guiding leaves and debris into the hose.

Reference will now be made in detail to the present preferred embodiments of the invention, examples of which are illustrated in the accompanying drawings. Wherever possible, the same reference numerals are used in the drawings and the description to refer to the same or like parts.

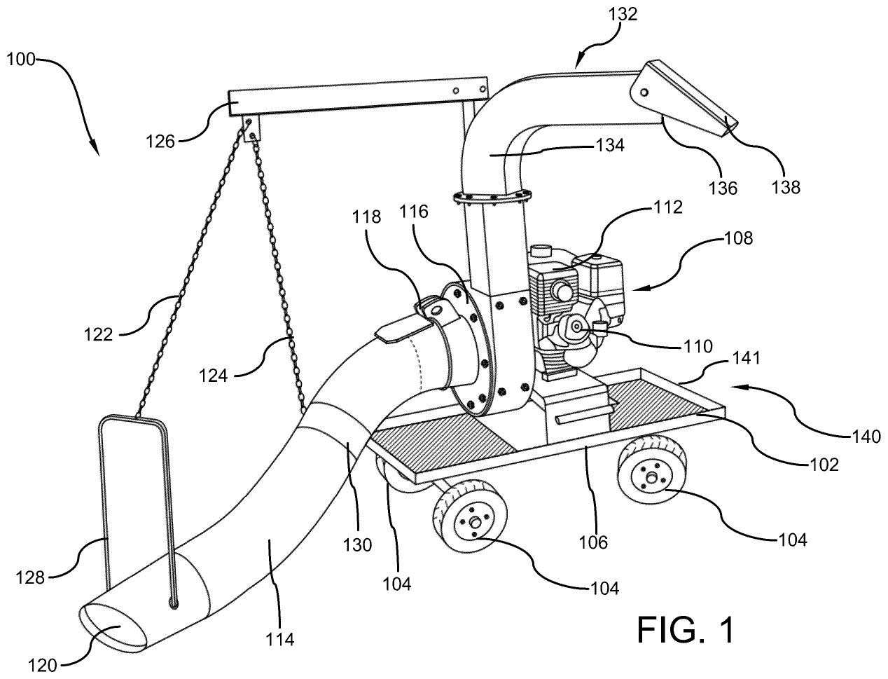

Referring initially to the drawings, FIG. 1 illustrates a perspective view of portable landscaping device of the present invention in accordance with the disclosed structure. The portable landscaping device 100 of the present invention is designed as a user-friendly landscaping device designed to empower individuals to perform various landscaping tasks without the need for professional help. More specifically, the landscaping device 100 includes a substantially horizontal platform 102 preferably made of metal or any other similar durable material. A plurality of casters or wheels 104 are attached to the bottom surface 106 of the platform 102 for easy portability of the landscaping device 100. The casters or wheels 104 enable the device 100 to be transported on different indoor and outdoor surfaces and preferably, the wheels 104 are large (i.e., at least eight (8) inches in diameter) and rugged to navigate various terrains including grass, dirt, gravel, and pavement.

The landscaping tool 100 includes a vacuum cleaner apparatus 108 for collecting leaves, debris, and more. The vacuum cleaner apparatus 108 includes a high-powered electric or battery-operated motor 110 that generates the necessary suction force to collect leaves and debris. A user-friendly control panel 112 is provided that enables users to control the vacuum on/off and adjust the suction power if needed. A vacuum hose 114 is attached to the vacuum port 116 of the cart and is secured using a lock 118. The lock 118 can be released to detach the hose 114 when it is not required or to be replaced with a new hose 114. The hose 114 is flexible and includes an open end 120 for enabling the leaves and debris to be sucked inside the hose 114. The length and the shape of the hose 114 can be customized as per preferences of the users and requirements of the landscaping.

The hose 114 can be positioned in any desired position to remove and clean debris, leaves, and more. Further, one or more chains 122, 124 is operatively connected to a metal stand 126 wherein the metal stand 126 is fastened to the platform 102. The metal chains 122, 124 can be used for supporting (i.e., suspending) different landscaping tools such as a leaf collector or handle 128 which can be positioned at (i.e., proximal to) the open end 120 of the hose 114 and a hose supporter 130.

A dispenser 132 extends vertically from the platform 102 and is preferably positioned in opposite direction of the open end 120 of the hose 114. The dispenser 132 is configured to release the collected leaves, debris, and more in real-time and includes a hollow pipe 134 which is operatively connected to the hose 114 for receiving the collected debris and leaves. A dispensing end 136 of the dispenser 132 is adapted to eject the collected debris and leaves and include a pivoting cap 138 which can protect the dispensing end 136 from physical damage. It will be apparent to a person skilled in the art that an upward pressure is created along the hollow pipe 134 towards the dispensing end 136 for dispensing the collected leaves, debris, and more.

A handle 140 is integrated to the front end 141 of the platform 102 for enabling a user to easily push and pull the device 100 along any surface. The hose 114 quickly and easily collects leaves and debris, reducing the time and effort needed for yard cleanup and the dispenser 132 easily dispenses the collected leaves and debris, thereby eliminating the need for additional leaf collection tools and professional services. The landscaping cart 100 can be moved to any desired area such that the leaves and debris can be released at any disposal area.

The platform 102 can be made from high-strength aluminum or steel and is resistant to weather conditions. The wheels 104 can be made from rubber or polyurethane with metal or plastic cores. The handle 140 can be made from aluminum or steel with rubber or foam grips to provide comfort and prevent slipping during use.

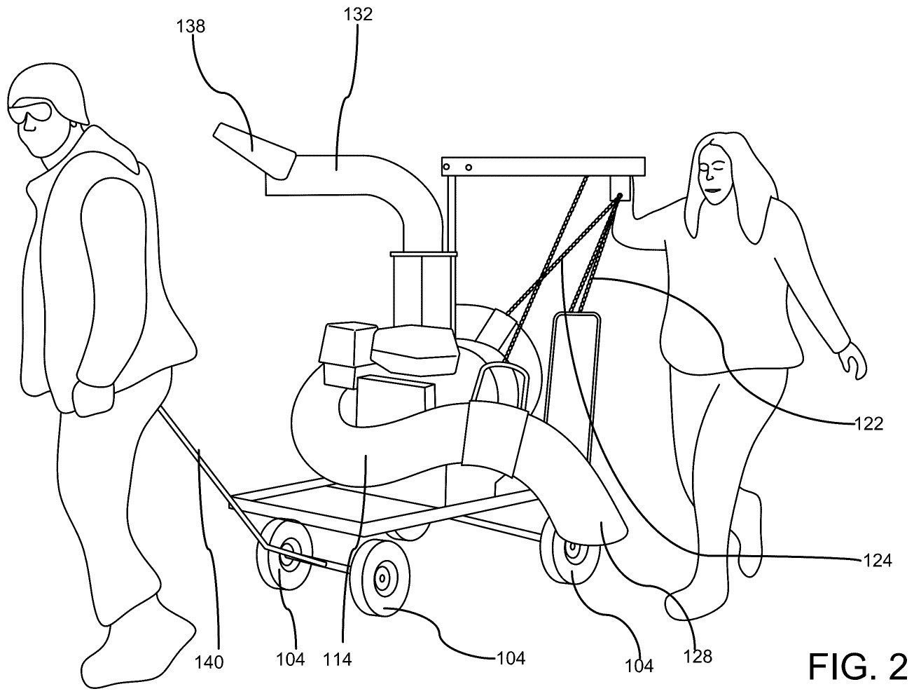

FIG. 2 illustrates a perspective view showing users carrying the landscaping cart device of the present invention in accordance with the disclosed structure. As illustrated, the landscaping cart 100 can be pulled or carried along a surface using the handle 140. The chains 122, 124 also provides support to the hose 114 with the landscaping tools 128, 130 supporting and accommodating portions of the hose 114. When the cart 100 is not used for landscaping, the vacuum cleaner apparatus 108 is not activated and accordingly, the hose 114 is not used for suction and the dispenser 132 is not used for dispensing.

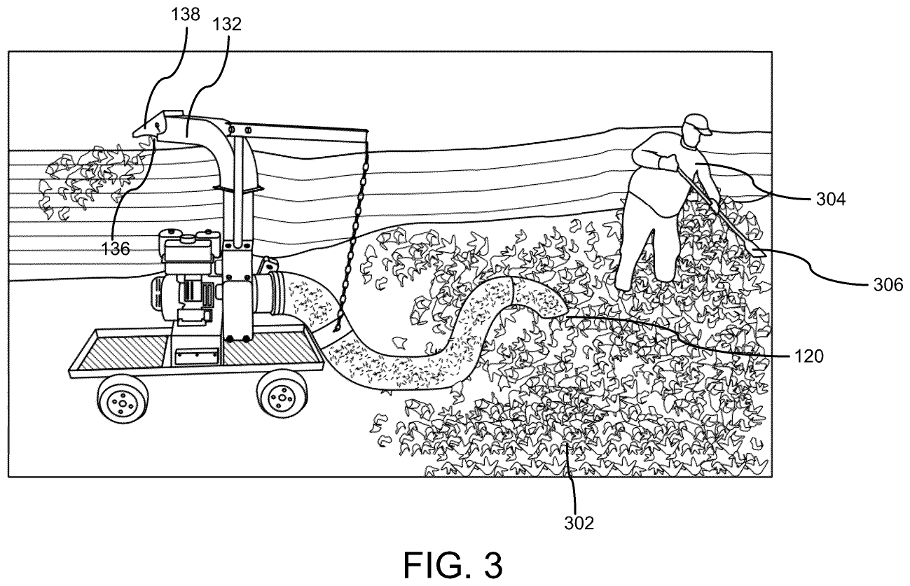

FIG. 3 illustrates a perspective view showing a user performing landscaping using the portable multifunctional landscaping device of the present invention in accordance with the disclosed structure. For using the device 100, the vacuum cleaner apparatus 108 is activated and the vacuum hose 114 is used for sucking or absorbing leaves 302 or any other landscaping material. A user 304 can just either using a scraper or any other tool 306 scrape the landscaping material near the open end 120 of the hose 114. The collected leaves 302 in real-time are transmitted from the hose 114 towards the dispenser 132 and are thrown out from the dispensing end 136 and can be dispensed into the disposal area 308 or open truck/trailer (not illustrated).

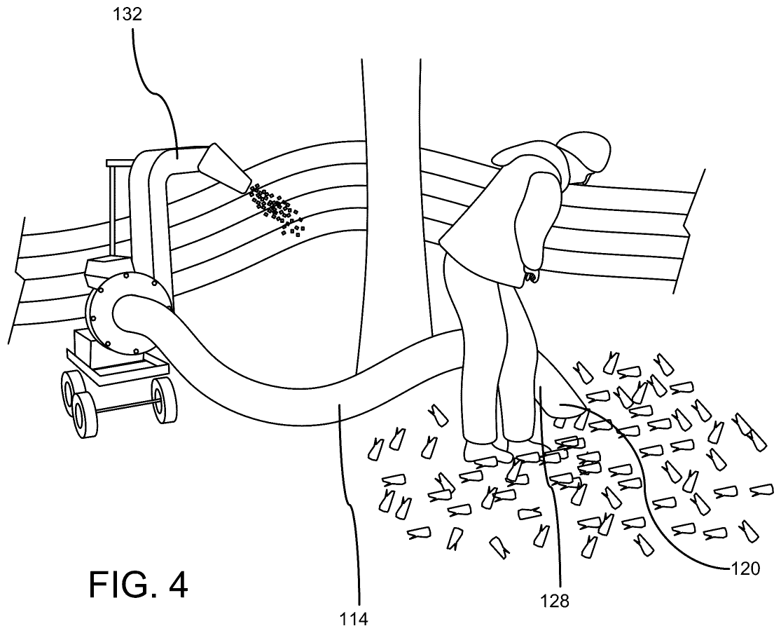

FIG. 4 illustrates a perspective view of showing a user holding the hose for performing landscaping in accordance with the disclosed structure. As illustrated, a user 402 can hold the leaf collector or handle 128 which is positioned at the open end 120 of the hose 114 for pointing the open end 120 to collect the leaves or any other landscaping material. The hose 114 can be up to 20 feet for reaching different landscaping areas and the hose 114 and the dispenser 132 can be adjusted at any desired positions to collect and dispense the landscaping material.

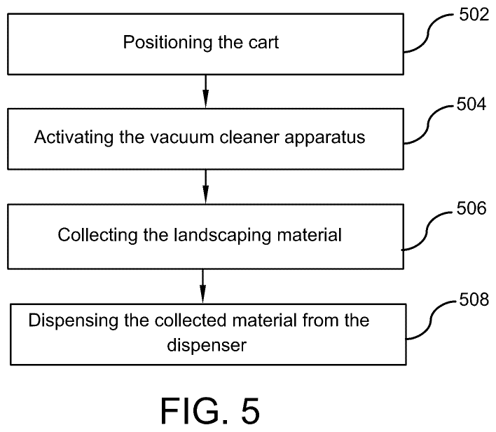

FIG. 5 illustrates a flow chart depicting a process of operation of the portable multifunctional landscaping device of the present invention in accordance with one embodiment of the present invention. Initially, the cart 100 is positioned at an appropriate location for collecting and dispensing landscaping material (Step 502). Then, the vacuum cleaner apparatus 108 is activated using the motor 110 for activating suction in the hose 114 and dispensing in the dispenser 132 (Step 504). Thereafter, the hose 114 is used for collecting the landscaping material and the collected material is transferred towards the dispenser 132 (Step 506). Finally, the material is dispensed through the dispensing end 136 of the dispenser 132 at a disposal area (Step 508).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “portable multifunctional landscaping device”, “portable landscaping device”, “landscaping tool”, and “landscaping cart” are interchangeable and refer to the portable multifunctional landscaping cart 100 of the present invention.

Notwithstanding the forgoing, the portable multifunctional landscaping cart 100 of the present invention can be of any suitable size and configuration as is known in the art without affecting the overall concept of the invention, provided that it accomplishes the above stated objectives. One of ordinary skill in the art will appreciate that the portable multifunctional landscaping cart 100 as shown in the FIGS. are for illustrative purposes only, and that many other sizes and shapes of the portable multifunctional landscaping cart 100 are well within the scope of the present disclosure. Although the dimensions of the portable multifunctional landscaping cart 100 are important design parameters for user convenience, the portable multifunctional landscaping cart 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable landscaping device comprising:
a landscaping device;
a platform; and
a plurality of casters;
wherein said landscaping is a vacuum device for collecting debris;
wherein said platform is horizontal;
wherein said plurality of casters attached to a bottom surface of said platform;
wherein said platform having a material of metal; and
further wherein said plurality of casters are a plurality of wheels.

2. The portable landscaping device of claim 1, wherein each of said plurality of wheels having a diameter of at least eight inches.

3. The portable landscaping device of claim 1, wherein said vacuum device having a battery operated motor for generating a suction force for collecting of the debris.

4. The portable landscaping device of claim 3, wherein said platform having a metal stand and a plurality of chains suspended therefrom for supporting a vacuum hose of said vacuum device.

5. The portable landscaping device of claim 4, wherein said vacuum hose is flexible and includes an open end for suction of the debris.

6. The portable landscaping device of claim 5, wherein said vacuum hose having a handle proximal to said open end and a hose supporter distal to said open end for controlled movement of said vacuum hose.

7. The portable landscaping device of claim 6, wherein at least one of said plurality of chains connected to said handle and at least another of said plurality of chains connected to said hose supporter for suspending said vacuum hose above the ground.

8. The portable landscaping device of claim 7, wherein said platform and said handle having a material selected from the group consisting of a steel and an aluminum.

9. A portable landscaping device comprising:
a landscaping device;
a platform;
a dispenser having a hollow pipe; and
a plurality of casters;
wherein said landscaping is a vacuum device for collecting debris;
wherein said platform is horizontal;
wherein said plurality of casters attached to a bottom surface of said platform;
wherein said platform having a material of metal;
wherein said platform having a metal stand and a plurality of chains suspended therefrom for supporting a vacuum hose of said vacuum device;
wherein said dispenser operatively connected to said vacuum hose;
wherein said dispenser extending vertically from said platform for ejecting the debris from said hollow pipe; and
further wherein said plurality of casters are a plurality of wheels.

10. The portable landscaping device of claim 9, wherein each of said plurality of wheels having a diameter of at least eight inches.

11. The portable landscaping device of claim 9, wherein said vacuum device having a battery operated motor for generating a suction force for collecting of the debris.

12. The portable landscaping device of claim 11, wherein said vacuum hose is flexible and includes an open end for suction of the debris.

13. The portable landscaping device of claim 12, wherein said vacuum hose having a handle proximal to said open end and a hose supporter distal to said open end for controlled movement of said vacuum hose.

14. The portable landscaping device of claim 13, wherein at least one of said plurality of chains connected to said handle and at least another of said plurality of chains connected to said hose supporter for suspending said vacuum hose above the ground.

15. The portable landscaping device of claim 14, wherein said platform and said handle having a material selected from the group consisting of a steel and an aluminum.

16. A portable landscaping device comprising:
a landscaping device;
a platform;
a dispenser having a hollow pipe; and
a plurality of wheels;
wherein said landscaping is a vacuum device for collecting debris;
wherein said platform is horizontal;
wherein said plurality of casters attached to a bottom surface of said platform;
wherein said platform having a material of metal;
wherein said platform having a metal stand and a plurality of chains suspended therefrom for supporting a vacuum hose of said vacuum device;
wherein said dispenser operatively connected to said vacuum hose;
wherein said dispenser extending vertically from said platform for ejecting the debris from said hollow pipe;
wherein said vacuum hose having a handle proximal to said open end and a hose supporter distal to said open end for controlled movement of said vacuum hose; and
further wherein at least one of said plurality of chains connected to said handle and at least another of said plurality of chains connected to said hose supporter for suspending said vacuum hose above the ground.

17. The portable landscaping device of claim 16, wherein each of said plurality of wheels having a diameter of at least eight inches.

18. The portable landscaping device of claim 16, wherein said vacuum device having a battery operated motor for generating a suction force for collecting of the debris.

19. The portable landscaping device of claim 18, wherein said vacuum hose is flexible and includes an open end for suction of the debris.

20. The portable landscaping device of claim 19, wherein said platform and said handle having a material selected from the group consisting of a steel and an aluminum.
